(19) United States
(12) Patent Application Publication
(10) Pub. No.: US 2008/0232585 A1
(43) Pub. Date: Sep. 25, 2008

(54) Method for Code Generation

(75) Inventor: Azman Bin H.J. Zahari, Petaling Jaya (MY)

Correspondence Address: NIXON & VANDERHYE, PC, 901 NORTH GLEBE ROAD, 11TH FLOOR, ARLINGTON, VA, 22203, US

(73) Assignee: ENTROPIC TECHNOLOGIES PTY LTD, East Perth, Western Australia (AU)

(21) Appl. No.: 12/063,965

(22) PCT Filed: Aug. 15, 2006
(86) PCT No.: PCT/AU2006/001159

§ 371 Date: Feb. 15, 2008

(30) Foreign Application Priority Data
Aug. 18, 2005 (AU) 2005904465

(51) Int. Cl. H04L 9/00; H04L 9/28; H04K 1/00

(52) U.S. Cl. 380/255; 380/277; 380/28

(57) ABSTRACT

A method for generating codes for encrypting data of an encrypting device and for decrypting said data by a decrypting device. The method includes the steps of providing a personal identification code to the encrypting device, the personal identification code being known or obtainable by the decrypting device, and selecting from a set of code generation parameters a current code generation parameter. The encryption code for encrypting the data of the encrypting device is generated by an algorithm, the algorithm being a function of the current code generation parameter and the personal identification code. The current code generation parameter is either known to the decrypting device based on its position in the sequence of said code generation parameters, or is transmitted to the decrypting device such that the decrypting device can generate the encryption code using the current code generation parameter, the personal identification code and the algorithm to allow decryption of the data.

### FIELD OF THE INVENTION

The present invention relates to a method of generating encryption codes to be used to encrypt data.

### BACKGROUND OF THE INVENTION

The applicant's own earlier International Patent application number WO2004088917 discloses a system and method for encrypting communication across a communication network. In that document, the described system utilises synchronised code generation means at both ends of the communication link. The code generation means each regularly, and in synchronization, change the codes used so that at any time, encrypted messages sent from one party to another can be correctly decoded by the encryption code that is current at that time.

This system requires the device calculating the code to be able to maintain synchronization for extended periods of time. With many battery powered devices, this arrangement may be difficult to employ.

The present invention attempts to overcome at least in part the aforementioned problem by providing a method for generating changing codes for securing data.

### SUMMARY OF THE INVENTION

In accordance with one aspect of the present invention there is provided a method for generating codes for encrypting data of an encrypting device and for decrypting said data by a decrypting device comprising the steps of:

providing a personal identification code to the encrypting device, the personal identification code being known or obtainable by the decrypting device;

selecting from a set of code generation parameters a current code generation parameter; and

generating said encryption code for encrypting the data of the encrypting device by an algorithm, the algorithm being a function of the current code generation parameter and the personal identification code;

wherein the current code generation parameter is either known to the decrypting device based on its position in the sequence of said code generation parameters, or is transmitted to the decrypting device such that the decrypting device can generate the encryption code using the current code generation parameter, the personal identification code and the algorithm to allow decryption of the data.

### BRIEF DESCRIPTION OF THE DRAWINGS

The present invention will now be described, by way of example, with reference to the accompanying drawings, in which:

FIG. 1 is a table of encryption codes generated from a sequence of code generation parameters using an algorithm being an MD5 Hash algorithm;

FIG. 2a is a table of encryption codes generated in accordance with the present invention from the sequence of code generation parameters of the table of FIG. 1 and a personal identification code of a first encrypting user; and

FIG. 2b is a table of encryption codes generated in accordance with the present invention from the sequence of code generation parameters of the table of FIG. 1 and a personal identification code of a second encrypting user.

### DESCRIPTION OFT THE INVENTION

The invention comprises a method of securing data by generating encryption codes that may be used to encrypt data by an encrypting device of an encrypting user and to decrypt said data by a decrypting device on an decrypting user. In particular, the method generates encryption codes that change so that different encryption codes may be used to encrypt the data at different times. The encryption codes may be used by the encrypting user to encrypt data for transmission across a communication network to the decrypting user, Alternatively, the data may be encrypted and stored by the encrypting user for later access. In this case, the encrypting user/device would be the same as the decrypting user/device.

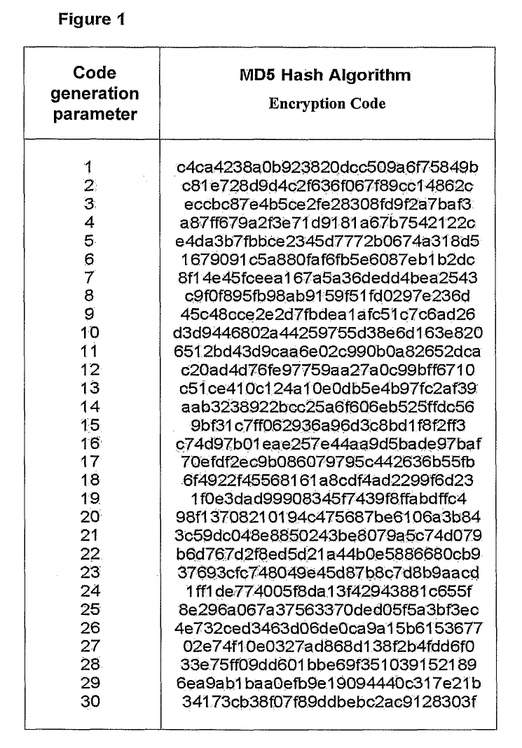

The encryption codes changes based on a code generation parameter that changes through a known sequence of code generation parameters. In the embodiment shown in FIG. 1, the code generation parameters comprise a simple sequence of integers as shown in the first column of the table. It will be appreciated however that the code generation parameters do not necessarily need to be integers, sequential numbers or decimal values. For example, the code generation parameters may be pseudo random numbers generated by an appropriate algorithm. Further, the code generation parameter may be represented in a graphical format, for example as a character or symbol defined to represent a corresponding binary value.

The table of FIG. 1 shows a method of generating encryption codes based on the code generation parameters that could be used to encrypt data transmitted between the encrypting user and the decrypting user. The encryption codes are generated by applying an algorithm to each of the code generation parameters to create a sequence of pseudo-random encryption codes. In the embodiment shown, the algorithm used comprises an MD5 Hash algorithm. It will be appreciated however that other algorithms may be used to achieve the desired result. The term algorithm is also used to encompass any function that may operate on the code generation parameter, such as XOR or right shift in the case of a binary code generation parameter.

This method may be used to generate an encryption code at the encrypting user's end to encrypt data. The decrypting user is also provided with the code generation parameter sequence and algorithm. The current code generation parameter is known to both the encrypting user and the decrypting user and therefore can be used to encrypt data transmitted between the encrypting user and the decrypting user. Ensuring that the decrypting user knows the current code generation parameter may be performed by a suitable method such as simply using the next code generation parameter in the sequence for each communication in a series of communications between the encrypting user and the decrypting user. Alternatively, the current code generation parameter may be transmitted from the encrypting user to the decrypting user, for example in the header of the transmitted data.

The encryption code is then generated only at the time required by the encrypting user for encrypting and transmitting, and the decrypting user for receiving and decrypting the transmitted message. The encryption codes previously used or to be used in the future are not stored at either the sending or receiving ends.

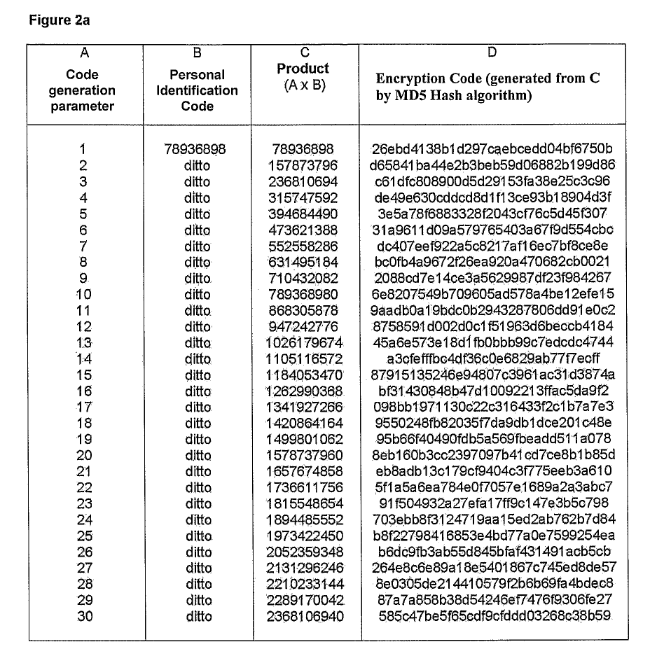

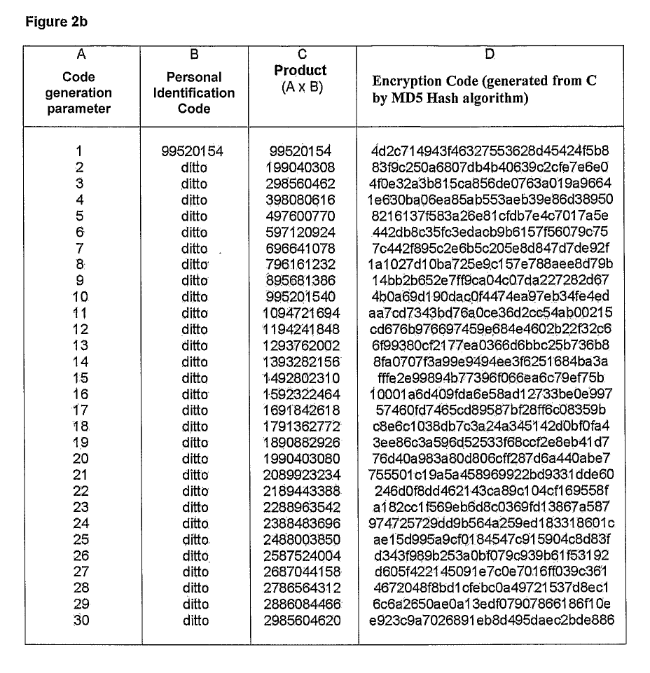

The tables of FIGS. 2a and 2b show the method in accordance with the present invention, in which the above mentioned method is modified to produce different encryption codes for different encrypting users. In the embodiment of the invention as shown in FIGS. 2a and 2b, the code generation parameter is again a sequence of integers. Each encrypting user using the method of the present invention is provided with a personalised identification code, as shown in the second column of the tables of FIGS. 2a and 2b.

The encryption codes are generated in the embodiment shown by applying the MD5 Hash algorithm to a product of the code generation parameter and the personal identification code. The encryption codes however may be generated by applying some other function of the code generation parameter and the personal identification code, not necessarily being the product. As can be seen, the inclusion of the personal identification code results in a different set of encryption codes being generated for a first encrypting user, as shown in FIG. 2a and a second encrypting user as shown in FIG. 2b. The use of an algorithm such as a one way hash results in encryption codes that, if intercepted, would make it difficult for the interceptor to use to identify either the code generation parameter sequence or the personal identification code.

For communications between various users, it may be required to employ a central code generation server that includes information including the personal identification codes of each user. As each user has only information of their own personal identification code and not the personal identification codes of other users, communication between users would need to be transmitted via the server. However some groups of users may utilise the same personal identification code. These users would therefore form a closed group in which direct communication would be possible without the need to obtain the personal identification code of other users.

The above mentioned method allows the use of a system having changing encryption codes without the need to having complete synchronisation in code generation at the sender and receiver ends. The method is therefore more suitable for devices such as mobile phones in which synchronisation may be more difficult to maintain.

In mobile phones for example, the method may be employed to encrypt text information transmitted between mobile phones in the form of sms messages. The method may be implemented in the form of application software on the mobile phone. The application software provides the functionality of generation of the encryption/decryption codes (thereby allowing encryption/decryption) described previously from the code generation parameter and personal identification code. The personal identification code is expected to be provided in the phone at implementation without the user actually knowing the code. In the event that a closed group, as described above, is employed, a set of phones having the same personal identification code is provided to each user of the group. The personal identification code would be provided in the phone in a secure manner such that a user, or someone who obtains the phone cannot uncover the personal identification code.

A remote means for purging the personal identification code or disabling the application software will also be provided. For example, the application software may include the ability to recognize one or more command messages transmitted to the device. The command messages will include a command that upon receipt by the application software either purges the personal identification code so that no transmissions can be encrypted or decrypted, or entirely disables the application software. In the event that an encrypting/decrypting device is lost or stolen, such a command may be sent to prevent unauthorised access. In the case of encrypted sms messages between mobile phones, certain characters may be used to indicate that the information transmitted comprises a system command, rather than a text message.

As described previously, the method may be employed for encrypting data for the purpose of storage and later retrieval by the same user. The use of constantly changing encryption codes that are never stored and an algorithm such as a One-Way Hash Algorithm means that decrypting a significant amount of data would require each encrypted data file to be individually decrypted and even obtaining sames of some codes generated would not allow discovery of the sequence of code generation parameters.

It is expected that the above method would be performed processing means provided to the sender and receiver under the control of suitable software.

Modifications and variations as would be apparent to a skilled addressee are deemed to be within the scope of the present invention

1. A method for generating codes for encrypting data of an encrypting device and for decrypting said data by a decrypting device comprising the steps of:
providing a personal identification code to the encrypting device, the personal identification code being known or obtained by the decrypting device;
selecting from a set of code generation parameters a current code generation parameters; and
generating an encryption code for encrypting the data of the encrypting device by an algorithm, the algorithm being a function of the current code generation parameter and the personal identification code;
wherein the current code generation parameter is either known to the decrypting device based on its position in the sequence of said code generation parameters, or is transmitted to the decrypting device such that the decrypting device can generate the encryption code using the current code generation parameter, the personal identification code and the algorithm to allow decryption of the data.

2. The method for generating codes in accordance with claim 1, wherein the code generation parameter is transmitted to the decrypting device with the encrypted data.

3. The method for generating codes in accordance with claim 1, wherein the encrypting device transmits to the decrypting device encrypted data having header information and the header information includes information from which the decrypting device can identify the code generation parameter required for decryption.

4. The method for generating codes in accordance with claim 1, wherein the selection of the code generation parameters comprises selecting the next code generation parameter from the sequence of code generation parameter each time is it required to encrypt data.

5. The method for generating codes in accordance with claim 4, wherein the code generation parameters comprise a sequence of integers.

6. The method for generating codes in accordance with claim 1, wherein the algorithm comprises a One-way Hash algorithm.

7. The method for generating codes in accordance with claim 1, wherein the encryption code is generated by applying the algorithm to the product of the code generation parameter and the personal identification code.

8. The method for generating codes in accordance with claim 1, wherein the personal identification code of the encrypting device and the receiving device are the same.

9. The method for generating codes in accordance with claim 1, wherein the decrypting device obtains the personal identification code of the encrypting device from a central code generation server connected to both the encrypting
and decrypting devices via a communications network.

10. The method for generating codes in accordance with claim 9, wherein the communications network is the Internet.

11. The method for generating codes in accordance with claim 1, including remotely purging the personal identification code from the decrypting device or disabling the decrypting device from decrypting and received data.

12. The method for generating codes in accordance with claim 1, wherein the encrypting and decrypting devices are implemented as application software on the device.

13. The method for generating codes in accordance with claim 12, including disabling the decrypting device so as to disable the application software.

14. The method for generating codes in accordance with claim 12, including remotely purging the personal identification code from the decrypting device or disabling the decrypting device from decrypting acts on commands received in header information transmitted to the device.
